(19) United States
(12) Patent Application Publication
(10) Pub. No.: US 2023/0377404 A1
(43) Pub. Date: Nov. 23, 2023

(54) METHOD FOR PROCESSING VALUE DOCUMENTS, AND VALUE DOCUMENT PROCESSING SYSTEM

(71) Applicant: GIESECKE+DEVRIENT CURRENCY TECHNOLOGY GMBH, Munchen (DE)

(72) Inventors: Tilo FRITZHANNS, Munchen (DE); Ralf HOBMEIER, Munchen (DE); Jens KULIKOWSKI, Oberding (DE); Andrej PIETSCHKER, Munchen (DE)

(21) Appl. No.: 18/031,059

(22) PCT Filed: Sep. 24, 2021
(86) PCT No.: PCT/EP2021/025366

§ 371 Date: Apr. 10, 2023

(30) Foreign Application Priority Data
Oct. 8, 2020 (DE) 10 2020 006 203.2

(51) Int. Cl. G07D 11/22; G07D 11/30; G07D 11/50

(52) U.S. Cl. CPC G07D 11/22; G07D 11/30; G07D 11/50

(57) ABSTRACT

A method and a value document processing system for processing value documents include: ascertaining first identification data by means of which the value documents contained in a plurality of different batches can be identified, in at least one value document processing device; generating assignment data; transmitting the first identification data to an external computing device; comparing the transmitted first identification data with specified second identification data by means of which value documents can be identified that are to be removed from circulation and/or are to remain in circulation; and, if the comparison indicates that at least one value document that is to be removed from circulation is contained in the value documents, identifying the batch in which the at least one value document is contained that is to be removed from circulation; and sorting the value documents.

The invention relates to a method for processing valuable documents, in particular banknotes, and to a valuable document processing system.

When valuable documents, in particular banknotes, are produced, they are usually provided, in particular printed, with an identification feature, for example a serial number. Such an identification feature makes it possible to identify a valuable document and, for example, assign it to a specific production batch. It is also possible to track a banknote in circulation by regularly recording its serial number or to register a banknote in a central database, for instance if this banknote has been involved in a crime, for example because it was stolen in a bank robbery or contained in a ransom payment, or it becomes known that counterfeits of this banknote have been put into circulation.

It is an object of the present invention to improve the processing, in particular the sorting, of valuable documents.

This object is achieved by the method and the valuable document processing system according to the independent claims.

The method according to the invention for processing valuable documents, in particular banknotes, contains the ascertainment, in at least one valuable document processing device, of first identification data, in particular serial numbers, using which the valuable documents contained in a plurality of different batches are identifiable. Furthermore, assignment data are generated, using which the first identification data of the valuable documents contained in the plurality of batches are assigned to the respective batch. The first identification data are then transmitted, in particular via an Internet service, to an external computing device, where the first identification data are compared with predetermined second identification data, in particular serial numbers, which render identifiable valuable documents that should be withdrawn from circulation and/or should remain in circulation. If the comparison has shown that the valuable documents contain at least one valuable document that should be withdrawn from circulation, the batch that contains the at least one valuable document that should be withdrawn from circulation is identified from the plurality of batches using the assignment data and a result of the comparison of the first identification data with the second identification data. Further, the valuable documents contained in the identified batch are then sorted in the at least one valuable document processing device on the basis of the result of the comparison of the first identification data with the second identification data.

The valuable document processing system according to the invention for processing valuable documents, in particular banknotes, has at least one valuable document processing device which is configured to ascertain first identification data, in particular serial numbers, using which the valuable documents contained in a plurality of different batches can be identified, and to transmit the first identification data, in particular via an Internet service, to an external computing device. The valuable document processing device is also configured to generate assignment data, using which the first identification data of the valuable documents contained in the plurality of batches are assigned to the respective batch, and to store the assignment data in a database. The valuable document processing system also has an external computing device which is configured to compare the first identification data with predetermined second identification data, in particular serial numbers, which render identifiable valuable documents that should be withdrawn from circulation and/or should remain in circulation. A checking device is configured to check whether the comparison has shown that the valuable documents contain at least one valuable document that should be withdrawn from circulation. A control device is configured to identify, from the plurality of batches, the batch containing the at least one valuable document that should be withdrawn from circulation using the assignment data stored in the database and a result of the comparison of the first identification data with the second identification data if the comparison has shown that the valuable documents processed by the at least one valuable document processing device contain at least one valuable document that should be withdrawn from circulation. In the process, the at least one valuable document processing device is also configured to sort the valuable documents contained in the identified batch on the basis of a result of the comparison of the first identification data with the second identification data.

One aspect of the invention is based on the approach of using first identification data, in particular serial numbers, which identify the valuable documents contained in a plurality of different batches, and predetermined second identification data in an external computing device to check whether valuable documents, or which of the valuable documents, should be withdrawn from circulation. Assignment data are also generated in addition to the first identification data and these assignment data are used to link the first identification data to the batch which contains or contained the respective valuable documents. The first identification data allow identification of that batch from a plurality of batches which contains or contained the valuable documents with these identification data. The assignment data preferably additionally contain location information on the location, in particular on the current location, at which the respective batch is located. This enables the processed batches to be tracked using the valuable documents they contain, with the result that, following the ascertainment of the first identification data, the batches can be further processed as desired, for example banded, picked and stored at a designated location in the cash center, without for instance having to be kept on or near the valuable document processing machine.

The second identification data are, for example, a so-called whitelist, which contains the identification data of valuable documents intended or released for circulation, or a so-called blacklist, which contains the identification data of valuable documents to be removed from circulation.

The identification data are preferably serial numbers or another individual feature of the respective valuable document, by which the individual valuable document can be identified. Alternatively or additionally, the identification data may also be information by means of which a plurality or a multiplicity of valuable documents can be identified, for example an assignment number which indicates a batch, a container, packaging or a specific issue or series of valuable documents, for example, to which the valuable documents belong. Such an assignment number can be used to easily withdraw entire series or partial series of valuable documents from circulation if the series in question exhibit for instance a printing defect or were issued for test purposes, and the corresponding number of the valuable document series is included in the blacklist or not included in the whitelist.

By comparing the first identification data with the predetermined second identification data in the external computing device, the identification data of those valuable documents that should be withdrawn from circulation are ascertained. On the basis of the result of the comparison, that is to say the identification data of the valuable documents to be removed from circulation ascertained in the process, that batch which contains the valuable documents with this identification data is then identified with the assignment data being taken into account. The valuable documents contained in the identified batch are subsequently sorted using the comparison result, with those valuable documents that should be withdrawn from circulation being sorted out.

As a rule, the plurality of the processed batches do not contain any valuable documents to be withdrawn from circulation, and so usually only relatively few batches have to be identified and sorted, whereas most batches do not contain any valuable documents to be removed from circulation and therefore no longer have to be sorted. The latter batches are therefore only processed once in the at least one valuable document processing device, specifically when ascertaining the first identification data. The above-described method is therefore also referred to as a “1-step process”. In contrast with a so-called “2-step process”, in which sorting is mandatory, that is to say all batches are sorted on the basis of the respective comparison results, only those batches which include at least one valuable document that should be withdrawn from circulation are sorted in the present 1-step process.

In the manner described above, valuable documents to be sorted out, for example valuable documents which are forged, defective and/or involved in a crime, can be withdrawn from circulation in a targeted and reliable manner, or all other valuable documents can be reliably returned to circulation. In addition, the comparison of the first identification data with the predetermined second identification data carried out in an external computing device—instead of in the valuable document processing device—allows the said second identification data to be managed, in particular updated, simply and centrally in the external computing device. The second identification data required for ascertaining the sorting data, for example in the form of a whitelist or blacklist, therefore do not need to be constantly updated in a decentralized manner on a plurality of valuable document processing devices.

An external computing device is preferably understood to mean a computer system, in particular a server, which is preferably located at a central location, for example the headquarters of a central bank, and is able to exchange data with the valuable document processing devices via an Internet connection. Alternatively, the external computing device can also be what is known as a cloud, which has a computer network for carrying out the above-described method steps.

By way of a suitable data connection between the valuable document processing device and the external computing device, in particular provided by an Internet service such as File Transfer Protocol (FTP), email or the World Wide Web (WWW), the valuable documents of the batch or batches identified in each case can be sorted in decentralized fashion or locally, that is to say at the location of the valuable document processing device, on the basis of the centrally specified current second identification data, should the comparison have revealed the need for sorting.

Overall, the invention thus allows improved processing of valuable documents, in particular more reliable sorting of valuable documents.

In a preferred embodiment, the result of the comparison of the first identification data with the second identification data contains first sorting data which render identifiable valuable documents that should be withdrawn from circulation and/or should remain in circulation. The batch containing the at least one valuable document that should be withdrawn from circulation is preferably identified using the assignment data and the first sorting data. Likewise, the valuable documents are preferably sorted in the at least one valuable document processing device on the basis of the first sorting data. In the process, the first sorting data are transmitted from the external computing device to the at least one valuable document processing device, in particular via an Internet service.

The first sorting data preferably contain identification data for those valuable documents that should be withdrawn from circulation. In this sense, the first sorting data correspond to a local blacklist or a blacklist adapted to the valuable documents processed by the at least one valuable document processing device.

Alternatively, the first sorting data can also contain identification data for those valuable documents that should remain in circulation. In this case, the first sorting data correspond to a local or adapted whitelist.

The above-described embodiments allow valuable documents which are to be withdrawn from circulation to be sorted out particularly reliably.

In a further preferred embodiment, one or more properties of the valuable documents are recorded in each case in the at least one valuable document processing device by means of one or more sensors, and corresponding sensor data are generated. The sensor data are transmitted, in particular via an Internet service, to the external computing device, in which the valuable documents are checked using the sensor data, in particular with regard to authenticity and/or condition, to the effect of whether one or more valuable documents should be withdrawn from circulation and/or should remain in circulation. If the check of the valuable documents on the basis of the sensor data has shown that the valuable documents contain at least one valuable document that should be withdrawn from circulation, the batch that contains the at least one valuable document that should be withdrawn from circulation is identified from the plurality of batches using the assignment data and a result of the check of the valuable documents on the basis of the sensor data. In addition, the valuable documents contained in the identified batch are sorted in the at least one valuable document processing device on the basis of the result of the check.

In this way, the valuable documents are reliably sorted in the at least one valuable document processing device also with regard to properties determinable using the sensor data, such as authenticity and/or fitness, with a time-consuming/complicated evaluation of the sensor data in the at least one valuable document processing device being able to be avoided.

In a further preferred embodiment, the result of the check of the valuable documents on the basis of the sensor data contains second sorting data which render identifiable valuable documents that should be withdrawn from circulation and/or should remain in circulation. The batch containing the at least one valuable document that should be withdrawn from circulation is preferably identified using the assignment data and the second sorting data. The valuable documents are preferably sorted in the at least one valuable document processing device on the basis of the second sorting data. As a result, valuable documents to be withdrawn from circulation can be sorted out particularly reliably.

In a further preferred embodiment, the first identification data of the valuable documents are rerecorded when the valuable documents contained in the identified batch are sorted in the at least one valuable document processing device, and the valuable documents contained in the identified batch are sorted using a comparison of the rerecorded first identification data with the first sorting data or second sorting data. Advantageously, it is sufficient if the at least one valuable document processing device, in which the valuable documents contained in the identified batch are sorted, is only able to read the first identification data, with the result that it is possible to dispense with a more extensive sensor system, including evaluation software.

In a further preferred embodiment, the method includes the following additional steps: in each case ascertaining one or more properties of the valuable documents in the at least one valuable document processing device by means of one or more sensors and generating corresponding sensor data, and selecting a portion of the first identification data using the sensor data, wherein the selected portion of the first identification data is transmitted to the external computing device. This makes it possible to dispense with checking a portion of the valuable documents in the external computing device with regard to the presence of their identification data in a blacklist or whitelist, for example if it is ascertained on the basis of the sensor data that the valuable documents need to be sorted out anyway, for instance on account of their poor condition.

In a further preferred embodiment, the ascertainment of the first identification data of the valuable documents and the sorting of the valuable documents contained in the identified batch are implemented in the same valuable document processing device. Here—if the result of the comparison of the first identification data with the second identification data requires sorting of the valuable documents—the valuable documents of the identified batches are fed again to the valuable document processing device in which the first identification data were determined at the start of the method. For this purpose, a signal which signals the need to sort the valuable documents contained in the identified batch or causes the sorting of these valuable documents can be output at the valuable document processing device, for example “Insert batch XX again for sorting!”. Alternatively, a corresponding notification can be output if the valuable documents contained in a batch no longer need to be sorted, for example “Batch YY OK!”, and can be processed in some other way, for example by being picked, packaged and/or returned to circulation.

In a further preferred embodiment, the ascertainment of the first identification data of the valuable documents is implemented in a first valuable document processing device and the sorting of the valuable documents contained in the identified batch is implemented in a second valuable document processing device that differs from the first valuable document processing device. In this case, the recording of the first identification data of the valuable documents and the possibly required sorting, in particular resorting of the valuable documents on the basis of the result of the comparison are preferably carried out in separate process steps which are, in particular, independent of one another in terms of time and/or location. As a result, after the first identification data has been recorded and the assignment data generated, the batches can also be transported to another cash center, where the sorting data may be made available and the sorting takes place, as part of further processing. The assignment data are also made available in the other cash center for this purpose.

In a further preferred embodiment, the predetermined second identification data are augmented with further second identification data which identify valuable documents whose check, in particular with regard to authenticity and/or condition, has shown that they should be withdrawn from circulation and/or should remain in circulation. These valuable documents are preferably checked for authenticity and/or condition using sensor data generated by sensors of the valuable document processing device and, depending on the result of the check, the associated serial numbers are included as further second identification data in a whitelist or blacklist stored in the external computing device. Within the scope of the usual processing method for valuable documents, this enables simple and reliable updating or expansion of a whitelist or blacklist formed from the predetermined second identification data.

In a further preferred embodiment, the valuable documents or a portion of the valuable documents are only released for circulation again following the ascertainment of the first identification data of the valuable documents if the comparison of the first identification data with the second identification data and optionally the check of the valuable documents using the sensor data has shown that the valuable documents contain no valuable document that should be withdrawn from circulation. In this case, all valuable documents contained in the batch can be put back into circulation. Alternatively, the valuable documents or a portion of the valuable documents are only released again if the sorting of the valuable documents contained in the identified batch in the at least one valuable document processing device has been implemented on the basis of the result of the comparison of the first identification data with the second identification data and optionally on the basis of the result of the check of the valuable documents using the sensor data. In this case, only those valuable documents contained in the batch that were not sorted out during the sorting process, for example due to suspected counterfeiting or involvement in a crime, can be put back into circulation, whereas the valuable documents that were sorted out undergo separate treatment, for example destruction, in order to no longer be able to be brought into circulation.

In the time between the ascertainment of the first identification data and the availability of the comparison result, according to which the batch must be sorted or no longer needs to be sorted, the batch is preferably kept safe or stored outside the valuable document processing device, possibly after packaging or bundling, for example by means of a currency strap. Safekeeping or storage should be understood as meaning any storage of the batches in which they cannot be brought into circulation. For example, the valuable documents are packed and/or picked in a cash center and/or stored in a vault without being able to leave the cash center. If a batch has to be sorted according to the comparison result, it is then placed back into the same or into another valuable document processing device for the purpose of sorting, possibly after removing the packaging or currency strap. Otherwise, the batch is released for circulation without having to be sorted.

Further advantages, features and application possibilities of the present invention arise from the following description in connection with the figures. In detail:

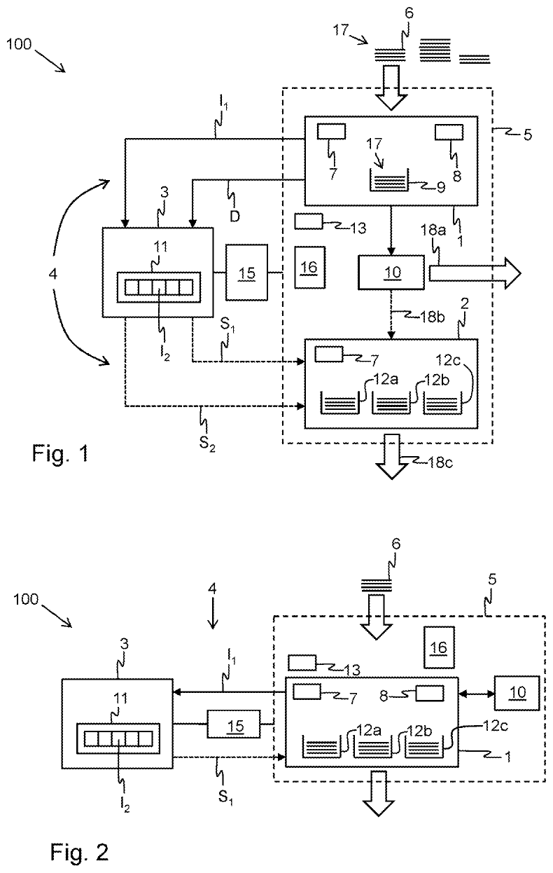

FIG. 1 shows a first example of a valuable document processing system; and

FIG. 2 shows a second example of a valuable document processing system.

FIG. 1 shows a first example of a valuable document processing system 100 having a first valuable document processing device 1, a second valuable document processing device 2, a checking device 15, a control device 16, and an external computing device 3, which is connected to the first and second valuable document processing device 1, 2, for example via an Internet service 4.

In the present example, a plurality of different batches 17 of valuable documents 6 are delivered to a cash center 5 in which the first and second valuable document processing devices 1, 2 are located. In the first valuable document processing device 1, first identification data I₁ of the valuable documents 6 contained in the batches 17 in each case are ascertained in order to identify the valuable documents 6, for example by processing images of the valuable documents 6 taken with a camera 7 using an algorithm for optical character recognition (OCR) and reading or identifying serial numbers printed on the valuable documents 6. Alternatively, the identification data I₁ may also already be recorded outside of the cash center 5, for example in the case of a so-called deposit killing, and may be delivered to the cash center 5 together with the valuable documents 6.

The first identification data I₁ are linked to the batches 17, in which the valuable documents 6 are contained in each case, with the aid of assignment data. By way of example, in addition to the first identification data of the valuable documents contained in a batch, the assignment data contain identity and/or location information relating to the identity or location of the batch. The assignment data are stored in a database 13, with the result that the batch 17 containing a specific valuable document 6 identifiable, for example, by a serial number is ascertainable at any time using the assignment data and is optionally also locatable within the cash center 5 using the location information.

In addition, in the present example, one or more properties of the valuable documents 6 are recorded by means of one or more sensors 8, for example infrared, ultrasonic, magnetic, optical and/or capacitive sensors. The sensors 8 generate corresponding sensor data D which characterize the relevant properties of the valuable documents 6.

Using the sensor data, it is also possible to identify double or multiple copies of valuable documents 6, output these to a corresponding output compartment of the valuable document processing device 1 and, from there, enter these back into the device 1 for ascertaining the first identification data I₁ of the valuable documents 6 contained in the double or multiple copies, in order to ensure that the first identification data I₁ of all valuable documents 6 contained in the respective batch 17 are ascertained.

The first identification data I₁ are transmitted together with the sensor data D to the external computing device 3 via the Internet service 4, while the batches 17 processed in the first valuable document processing device 1 are removed from a stacker 9, optionally banded and/or picked, and temporarily stored in a vault 10, for example.

In the external computing device 3, the first identification data I₁ are compared with predetermined second identification data I₂, in particular predetermined serial numbers, and the valuable documents 6 are checked with regard to authenticity and/or condition (so-called fitness) using the ascertained sensor data D.

The second identification data I₂ are stored in a database 11 in the external computing device 3 and form what is known as a whitelist, using which valuable documents 6 in circulation or intended for circulation can be identified. Alternatively, the second identification data I₂ form what is known as a blacklist, using which valuable documents 6 to be removed from circulation can be identified. In the process, provision can be made for the predetermined second identification data I₂ in the database 11 to be augmented with identification data from valuable documents 6 classified as counterfeit on the basis of the sensor data D, especially if this relates to a blacklist.

Using the comparison of the first identification data I₁ with the second identification data I₂ and optionally also using the check of the valuable documents 6 using the sensor data D, a check is carried out in the test device 15 as to whether there is at least one valuable document 6 that should be withdrawn from circulation. If this check shows that all of the valuable documents 6 temporarily stored in the vault 10 can be put back into circulation, the batches 17 may leave the cash center 5, in particular without prior sorting (arrow 18a). However, if the check shows that the batches 17 temporarily stored in the vault 10 contain one or more valuable documents 6 to be withdrawn from circulation, for example because they were involved in a crime, are counterfeit and/or are in bad condition (unfit), the control device 16 identifies those batches which contain these valuables documents. The identified batches are removed from the vault 10 and fed to the second valuable document processing device 2 for appropriate sorting (arrow 18b).

In the present example, first sorting data S₁ containing the identification data of valuable documents 6 that remain in circulation or should be removed from circulation are ascertained using the comparison of the first with the second identification data, I₁ and I₂, respectively. Accordingly, second sorting data S₂ containing the identification data of those valuable documents 6 whose authenticity or condition was classified as in order or not in order can be ascertained using the sensor data D.

The first and second sorting data S₁, S₂ are transmitted, preferably together or simultaneously, from the external computing device 3 to the second processing device 2 via the Internet service 4. Once the first and second sorting data S₁, S₂ are available in the cash center 5, the identified batches 17 can be removed from the vault 10 and fed to the second valuable document processing device 2 for the purpose of sorting. A period of several minutes or even hours may elapse between the processing of the valuable documents 6 in the first valuable document processing device 1 and the sorting of the valuable documents 6 in the second valuable document processing device 2.

In order to enable the valuable documents 6 contained in the identified batches 17 to be sorted using the first and second sorting data S₁, S₂, the second valuable document processing device 2 is configured to rerecord the first identification data I₁ of the corresponding valuable documents 6, for example by means of a camera 7. Using a comparison of the rerecorded first identification data I₁ and the transmitted first and second sorting data S₁, S₂, the second valuable document processing device 2 can sort the valuable documents 6 and, for example, output them into different stackers 12a, 12b, 12c, with a stacker 12c preferably containing those valuable documents 6 from the identified batches 17 that should be withdrawn from circulation. Alternatively, these valuable documents 6 can also be fed directly to a valuable document destruction device (not shown).

Preferably, the identification data of the valuable documents 6 sorted out in the stacker 12c can be transmitted to the external computing device 3 via the Internet service 4 so that the predetermined second identification data I₂ can be updated accordingly in the database 11, for example by virtue of removing from the whitelist the serial numbers of the valuable documents 6 that have been destroyed or taken out of circulation. The serial numbers of destroyed valuable documents 6 are preferably not included in a blacklist in order not to excessively increase the scope of the blacklist.

By contrast, the valuable documents 6 output into the first and second stackers 12a, 12b can leave the cash center 5 after sorting and be put back into circulation (white arrow 18c).

The system described above has the particular advantage that the second identification data 12, for example in the form of a blacklist or whitelist, which contains a large number of entries and therefore requires a lot of storage space, are stored and managed centrally and, for instance, do not have to be available in a decentralized manner in the relevant valuable document processing devices 1, 2 or in each cash center 5. Problems due to insufficient storage and/or computing power of the valuable document processing devices 1, 2 or of the cash center 5 are thereby avoided. Further, on account of the outsourcing of the generally time-consuming comparison or checking process to the external computing device 3, the valuable document processing devices 1, 2 are only required during the recording of the first identification data or sorting of the valuable documents contained in a batch and are then immediately available again for further batches, whereby overall an efficient processing of a number or multiplicity of valuable document batches is made possible.

As an alternative to the above-described example of a valuable document processing system 100, in which the ascertainment of the first identification data of the valuable documents 6 and the sorting of the valuable documents 6 using the first and optionally second sorting data are carried out in different valuable document processing devices 1, 2, it is possible to carry out both process steps in just one valuable document processing device appropriately configured to this end, as will be explained in more detail below.

FIG. 2 shows a second example of a valuable document processing system 100 having a valuable document processing device 1, a checking device 15, a control device 16, and an external computing device 3, which is connected to the valuable document processing device 1 via an Internet service 4.

In the present example, the valuable documents 6 delivered to a cash center 5 are first checked in the valuable document processing device 1 using the properties of the valuable documents 6 recorded by one or more sensors 8, in particular with regard to value and/or authenticity and/or condition, and are output into various stackers 12a, 12b, 12c in accordance with their properties or the result of the check carried out.

Further, first identification data I₁ of the valuable documents 6, for example serial numbers printed on the valuable documents 6, are ascertained by virtue of images of the valuable documents 6 taken with a camera 7 are processed by means of optical character recognition (OCR).

The batches contained in the respective stackers 12a, 12b, 12c are removed and processed further in batches, for example banded, bundled, stacked in an ATM cassette and/or picked, and temporarily stored in the cash center 5, for example in a vault 10. The valuable document processing device 1 is then available again for the processing of further valuable documents 6, that is to say the determination of first identification data I₁, checking, and output into the stackers 12a, 12b, 12c.

With the aid of assignment data, the first identification data I₁ of the valuable documents 6 are linked to the batches respectively output in the stackers 12a, 12b, 12c. By way of example, in addition to the first identification data of the valuable documents respectively contained in a batch, the assignment data contain identity and/or location information relating to the identification or location of the batch. For example, batch identity information may be: “Stacker 1/Batch No. 1”, “Stacker 1/Batch No. 2”, “Stacker 1/Batch No. 3” etc., “Stacker 2/Batch No. 1”, “Stacker 2/Batch No. 2”, “Stacker 2/Batch No. 3” etc., or “Stacker 3/Batch No. 1”, “Stacker 3/Batch No. 2”, “Stacker 3/Batch No. 3” etc.

Using the assignment data stored in a database 13, it is then possible to ascertain the batch containing a specific valuable document 6 identifiable, for example, by a serial number at any time and it is optionally also possible to locate this batch within the cash center 5 using the location information.

The first identification data I₁ of the valuable documents 6 are transmitted via the Internet service 4 to the external computing device 3 and are compared there with predetermined second identification data I₂ stored in a database 11 of the external computing device 3. Like in the example shown in FIG. 1, the predetermined second identification data I₂ preferably form a whitelist or blacklist. The above statements in connection with FIG. 1 apply accordingly.

The comparison of the first and second identification data in the external computing device 3 generates corresponding sorting data S₁ which contain the identification data of the valuable documents to be withdrawn from circulation and are transmitted back to the cash center 5 via the Internet service 4.

The checking device 15 uses the comparison result, in particular the sorting data S₁, to check whether the valuable documents 6 contain at least one valuable document 6 to be withdrawn from circulation. If the result of this check is positive, the batch containing the at least one valuable document to be withdrawn from circulation, for example “Stacker 2/Batch No. 3”, is ascertained in the control device 16 using the assignment data stored in the database 13. This batch is then removed from the vault 10 and fed back to the valuable document processing device 1 and sorted according to the comparison result, in particular on the basis of the sorting data S₁. To this end, the first identification data of the valuable documents contained in the relevant batch are ascertained again and compared with the identification data contained in the sorting data S₁. Depending on whether or not the newly ascertained first identification data correspond to the identification data contained in the sorting data S₁, the corresponding valuable documents of the batch are output into different stackers, for example into the stacker 12a or 12b. In the present example, the valuable documents to be removed from circulation are output into the stacker 12a in the case of this sorting, while the valuable documents intended for renewed circulation are output into the stacker 12b. The former can then be destroyed, for example, while the latter can leave the cash center 5 again and be put into circulation.

In a variant of the process described above with reference to FIG. 2, provision can be made for only the first identification data of the valuable documents contained in specific or selected batches to be transmitted from the valuable document processing device 1 to the external computing device 3 for comparison purposes and to be linked by means of assignment data to the selected batches. Accordingly, the sorting data S₁ ascertained in the external computing device 3 may contain only identification data of valuable documents contained in the selected batches.

If, for example, valuable documents classified as authentic and fit are output into the stackers 12a and 12b and valuable documents classified as counterfeit and/or unfit are output into the stacker 12c during the initial check of the valuable documents with regard to authenticity and fitness, then it is more efficient to only transmit the first identification data of the valuable documents contained in the stackers 12a and 12b to the external computing device 3 for comparison with a whitelist and only generate corresponding assignment data since renewed circulation of the batch contained in the stacker 12c is now out of the question anyway.

Accordingly, the system 100 is configured in such a way that valuable documents whose first identification data have been transmitted to the external computing device may only leave the cash center 5 again once the comparison result is available and, should renewed sorting be required, the relevant batch has been sorted on the basis of the sorting data S₁.

A whitelist stored in a database 11 of a valuable document processing system 100 according to FIG. 1 or 2 is preferably created or updated according to the method described in more detail below.

Preferably, valuable documents are already provided during their production with second identification data, in particular serial numbers, which are recorded during or after their production and stored in the database 11. The second identification data are linked in the database 11, preferably with specific features of the valuable documents or production parameters, for example by virtue of being labeled as “not issued” and/or labeled with the time and/or place of production.

At the time the valuable documents are issued, that is to say when the valuable documents are put into circulation, the corresponding identification data in the database 11 are then labeled as “issued”, with the result that all second identification data with the feature “issued” then form the whitelist.

If valuable documents in circulation are later destroyed in a valuable document processing device, the identification data of these valuable documents can be recorded in the process and transmitted to the database 11. In the process, a search is made in the database 11, that is to say in the whitelist, for the corresponding identification data of the destroyed valuable documents and these are labeled as “destroyed”.

Further features of the valuable documents relating to the valuable documents and/or the destruction process can also be recorded and transmitted and linked to the second identification data in the database 11. Such features can be, for example, the time and place of destruction, an identification number of the valuable document processing device and/or identification information of a user.

Alternatively, the second identification data in the database 11 can also be updated manually, for example by virtue of labeling identifying data from valuable documents that have not been destroyed by a valuable document processing device as “destroyed”.

An up-to-date whitelist is always available in the database 11 as a result of this method.

Further preferred aspects in connection with the comparison of first and second identification data and the maintenance or updating of the whitelist are described below.

When the first and second identification data are compared in the external computing device 3, the second identification data I₂ stored in the database 11 are preferably searched for the transmitted first identification data I₁. If the second identification data I₂ that correspond to the first identification data I₁ are found, the date and time of the comparison of the first identification data I₁ with the second identification data I₂ can be stored in the database 11 and linked with the second identification data I₂.

If no second identification data I₂ that correspond to the first identification data I₁ are found or if the found second identification data I₂ are not labeled as “issued”, for example labeled as “not issued” or “destroyed”, then the corresponding first identification data I₁ are transmitted to the cash center 5, for example to a database or another management system of the cash center 5 (a so-called vault management system), as first sorting data S₁. The first sorting data S₁ can then be included in a local blacklist in the cash center 5 and be made available to the valuable document processing devices of the cash center 5. In this way, the local blacklist in the cash center is preferably updated at regular time intervals, for example every 10 minutes.

With every further processing of the valuable documents by the valuable document processing devices in the cash center 5, for example when sorting according to value and/or wear and tear, the first identification data I₁ of the valuable documents are rerecorded and compared with the local blacklist, in particular the first sorting data S₁. If there is a match between first identification data I₁ and the local blacklist or the first sorting data S₁, then appropriate messages can be output to an employee of the cash center 5 and the valuable documents in question can be output into an output compartment for rejected valuable documents, from where they can be removed by the employee and fed to a separate processing for valuable documents suspected of being forged.

1.-11. (canceled)

12. A method for processing valuable documents, in particular banknotes, including the following steps:
ascertaining first identification data, in particular serial numbers, using which the valuable documents contained in a plurality of different batches are identifiable, in at least one valuable document processing device,
generating assignment data, using which the first identification data of the valuable documents contained in the plurality of batches are assigned to the respective batch,
transmitting the first identification data, in particular via an Internet service, to an external computing device,
comparing the transmitted first identification data with predetermined second identification data, in particular serial numbers, which render identifiable valuable documents that should be withdrawn from circulation and/or should remain in circulation, in the external computing device and,
if the comparison has shown that the valuable documents contain at least one valuable document that should be withdrawn from circulation,
identifying the batch containing the at least one valuable document to be withdrawn from circulation from the plurality of batches using the assignment data and a result of the comparison of the first identification data with the second identification data, and
sorting the valuable documents contained in the identified batch in the at least one valuable document processing device on the basis of the result of the comparison of the first identification data with the second identification data.

13. The method according to claim 12, wherein
the result of the comparison of the first identification data with the second identification data contains first sorting data which render identifiable valuable documents that should be withdrawn from circulation and/or should remain in circulation,
the batch containing the at least one valuable document that should be withdrawn from circulation is identified using the assignment data and the first sorting data, and
the valuable documents are sorted in the at least one valuable document processing device on the basis of the first sorting data.

14. The method according to claim 12, including the following further steps:
in each case recording one or more properties of the valuable documents in the at least one valuable document processing device by means of one or more sensors and generating corresponding sensor data,
transmitting the sensor data, in particular via an Internet service, to the external computing device,
checking the valuable documents, in particular with regard to authenticity and/or condition, using the sensor data in the external computing device, to the effect of whether one or more valuable documents should be withdrawn from circulation and/or should remain in circulation, and,
if the check of the valuable documents using the sensor data has shown that the valuable documents contain at least one valuable document that should be withdrawn from circulation,
identifying the batch containing the at least one valuable document to be withdrawn from circulation from the plurality of batches using the assignment data and a result of the check of the valuable documents using the sensor data, and
sorting the valuable documents contained in the identified batch in the at least one valuable document processing device on the basis of the result of the check.

15. The method according to claim 14, wherein
the result of the check of the valuable documents using the sensor data contains second sorting data which render identifiable valuable documents that should be withdrawn from circulation and/or should remain in circulation,
the batch containing the at least one valuable document that should be withdrawn from circulation is identified using the assignment data and the second sorting data, and
the valuable documents are sorted in the at least one valuable document processing device on the basis of the second sorting data.

16. The method according to claim 13, wherein the first identification data of the valuable documents are rerecorded when the valuable documents contained in the identified batch are sorted in the at least one valuable document processing device and the valuable documents contained in the identified batch are sorted using a comparison of the rerecorded first identification data with the first sorting data or second sorting data.

17. The method according to claim 12, including the following further steps:
in each case ascertaining one or more properties of the valuable documents in the at least one valuable document processing device by means of one or more sensors and generating corresponding sensor data, and
selecting a portion of the first identification data using the sensor data,
wherein the selected portion of the first identification data is transmitted to the external computing device.

18. The method according to claim 12, wherein the ascertainment of the first identification data of the valuable documents and the sorting of the valuable documents contained in the identified batch are implemented in the same valuable document processing device.

19. The method according to claim 12, wherein the ascertainment of the first identification data of the valuable documents is implemented in a first valuable document processing device and the sorting of the valuable documents contained in the identified batch is implemented in a second valuable document processing device that differs from the first valuable document processing device.

20. The method according to claim 12, wherein the predetermined second identification data are augmented with further second identification data which identify valuable documents whose check, in particular with regard to authenticity and/or condition, has shown that they should be withdrawn from circulation and/or should remain in circulation.

21. The method according to claim 12, wherein the valuable documents or a portion of the valuable documents are only released for circulation again following the ascertainment of the first identification data of the valuable documents if
the comparison of the first identification data with the second identification data and optionally the check of the valuable documents using the sensor data has shown that the valuable documents contain no valuable document that should be withdrawn from circulation, or
the sorting of the valuable documents contained in the identified batch in the at least one valuable document processing device has been implemented on the basis of the result of the comparison of the first identification data with the second identification data and optionally on the basis of the result of the check of the valuable documents using the sensor data.

22. A valuable document processing system for processing valuable documents in particular banknotes, having
at least one valuable document processing device, which is configured to ascertain first identification data, in particular serial numbers, using which the valuable documents contained in a plurality of different batches are identifiable, to transmit the first identification data, in particular via an Internet service, to an external computing device, to generate assignment data, using which the first identification data of the valuable documents contained in the plurality of batches are assigned to the respective batch, and to store the assignment data in a database,
an external computing device which is configured to compare the transmitted first identification data with predetermined second identification data, in particular serial numbers, which render identifiable valuable documents that should be withdrawn from circulation and/or should remain in circulation,
a checking device which is configured to check whether the comparison has shown that the valuable documents contain at least one valuable document that should be withdrawn from circulation, and
a control device which is configured to identify, from the plurality of batches, the batch containing the at least one valuable document that should be withdrawn from circulation using the assignment data stored in the database and a result of the comparison of the first identification data with the second identification data if the comparison has shown that the valuable documents contain at least one valuable document that should be withdrawn from circulation,
wherein the at least one valuable document processing device is also configured to sort the valuable documents contained in the identified batch on the basis of a result of the comparison of the first identification data with the second identification data.
